(19) United States
(12) Patent Application Publication
(10) Pub. No.: US 2004/0198223 A1
(43) Pub. Date: Oct. 7, 2004

(54) Flow control in a bluetooth wireless communication system

(76) Inventors: Weng Wah Loh, Filton (GB); John Deryk Waters, Bath (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/265,914

(22) Filed: Oct. 8, 2002

(51) Int. Cl. H04B 5/00; H04B 1/40

(52) U.S. Cl. 455/41.1; 455/74

(57) ABSTRACT

Flow control is achieved in a Bluetooth wireless communication system by providing a buffer memory shared between an application layer and an L2CAP layer. The buffer memory is managed from the L2CAP layer to provide robust and stable flow control, particularly in a multi-channel environment. Optionally, the L2CAP layer schedules payload data transmission according to channel priorities, and offers a high integrity mode with error checking by adding error control data to the payload data.

The present invention relates in general to a flow control method for a Bluetooth wireless communication system, and to a Bluetooth wireless communication system that employs flow control.

A specification of the Bluetooth wireless communication system is published at www.bluetooth.org. See version 1.1, dated 22 Feb. 2001. Bluetooth is a trade mark of Bluetooth SIG, Inc.

The Bluetooth wireless communication system allows high-speed radio-frequency communications between a wide variety of devices. In particular, communications links are established that allow data transmission between a transmit device and a receive device, which each form part of a local network or piconet. It is desired to control the flow of data between the devices, particularly to avoid errors such as buffer overflow.

The Bluetooth specification version 1.1 provides an automatic flow control mechanism in a baseband layer. Here, baseband data packets include a 1-bit flow control indicator that either allows (FLOW=1) or stops (FLOW=0) the transmission of payload data from an L2CAP layer of a transmit device.

As use of the Bluetooth wireless communication system becomes more widespread, then increasingly it is desired to provide multiple logical communication channels, allowing transmission of payload data selectively to each of a plurality of applications running on a particular device. However, the Bluetooth specification version 1.1 is not primarily designed to service a number of applications simultaneously, and does not provide a high degree of stability for this purpose.

The Bluetooth specification version 1.1 allows only one logical data channel to be serviced at any instant in time. That is, one payload data packet must be completely transferred before another payload data packet can be scheduled. As a result, most applications employ transmit and receive buffers to assist the flow of payload data to or from that application. Each application is solely responsible for managing its own transmit and receive buffers. The automatic flow control mechanism of the baseband layer is not effective in such a multi-channel environment and is typically disabled.

When the automatic flow control mechanism of the Bluetooth specification version 1.1 is disabled or circumvented by flow control mechanisms in an application layer, a problem arises in that a flow error is increasingly likely to occur, rending inoperable the entire physical Bluetooth communications link to that device. Multi-purpose devices such as PCs, laptop or notebook computers, and PDAs (personal digital assistants) are making increasing use of the Bluetooth wireless communication system. As a result, poorly-design applications have become more widespread, further increasing the risk of flow control errors. In a multi-channel environment, a flow error will affect not only the application causing the error, but also affects applications on other channels, because the entire link is blocked by the flow error.

An aim of the present invention is to provide a method and apparatus for flow control in a Bluetooth wireless communication system. Preferred aims are to provide flow control which is stable and robust, even in a multi-channel environment. A further preferred aim is to provide flow control in a manner which is simple and cost-effective, in particular to minimise computational impact, use of resources, transmission overhead, and latency.

One particularly preferred embodiment of the invention aims to provide a method and apparatus for scheduling transmissions in a multi-channel environment, such that some transmissions have higher priority than others.

Another preferred embodiment of the invention aims to provide a method and apparatus for checking data errors, in a manner which is simple, robust and reliable.

According to a first aspect of the present invention there is provided a flow control method for use in a Bluetooth wireless communication system that includes a transmit device and a receive device, the transmit and the receive devices each comprising an application layer, an L2CAP layer, and one or more lower layers, each of the devices including a buffer memory shared between the application layer and the L2CAP layer, the method comprising the steps of: in the transmit device, writing payload data from the application layer into the buffer memory, and transmitting the payload data from the buffer memory through the L2CAP layer; and in the receive device, placing payload data received through the L2CAP layer into the buffer memory, and reading payload data from the buffer memory into the application layer.

Preferably the method comprises the steps of controlling the shared buffer memory using a set of buffer control pointers; updating at least one of the set of buffer control pointers, from the application layer; and updating at least one of the buffer control pointers, from the L2CAP layer. Preferably, the set of buffer control pointers includes a head pointer and a tail pointer, and the method comprises: updating the head pointer using the application layer, to show that new payload data has been written into the buffer memory of the transmit device; and updating a tail pointer of the outgoing buffer memory of the transmit device using the L2CAP layer, to show that payload data has been successfully transmitted. Preferably, the buffer memory of the transmit device comprises an outgoing buffer memory, and further comprises calculating free space in the outgoing buffer memory of the transmit device using the head and tail pointers, prior to writing payload data from the application layer into the buffer memory.

Preferably the buffer memory of the receive device comprises an incoming buffer memory, and the method further comprises, in the transmit device, predicting available space in the incoming buffer memory of the receive device, prior to transmitting payload data to the receive device. Preferably, in the transmit device, a set of buffer control pointers for the outgoing buffer memory, including a head pointer, a tail pointer, and an internal pointer are maintained, such that the head and tail pointers denote a start and end, respectively, of current payload data in the outgoing buffer memory. The internal pointer distinguishes untransmitted current data from transmitted current data. The transmit device also calculates the size of the transmitted current data using the set of control pointers of the outgoing buffer memory, to predict available space in the incoming buffer memory of the receive device.

The method may comprise, in the receive device, confirming that available space exists in the buffer memory of the receive device, prior to writing received payload data from the L2CAP layer into the buffer memory.

Preferably the method comprises sending an acknowledgement from the L2CAP layer of the receive device to the L2CAP layer of the transmit device, when payload data is read from the buffer memory of the receive device by the application layer; and in the transmit device, updating a tail pointer representing the end of current data in the buffer memory of the transmit device, in response to the acknowledgement, to show that the read payload data has been successfully transmitted. Preferably, the acknowledgement includes a size field indicating a number of bytes that have been read, and-the method comprises, in the transmit device, checking that the read number of bytes falls at a packet boundary.

Preferably the method comprises in the transmit device, determining a flow control error; and re-transmitting payload data from the outgoing buffer memory.

Preferably the method comprises establishing a transmission link between the transmit device and the receive device; and exchanging configuration parameters including a maximum size of the buffer memory and the transmit device and the buffer memory of the receive device.

The method may comprise negotiating a transmission channel between the transmit device and the receive device, including negotiating either a legacy mode without flow control in the L2CAP layer or an enhanced mode that includes flow control in the L2CAP layer.

In one particularly preferred embodiment, the method comprises establishing a plurality of transmission channels, each transmission channel having a priority level amongst a plurality of predetermined priority levels; and scheduling transmission of payload data in the outgoing buffer, according to the priority level of the transmission channel of the payload data.

In another particularly preferred embodiment the method comprises negotiating a high integrity mode between the transmit device and the receive device; at the transmit device, forming error control data in the L2CAP layer for each packet of payload data, and transmitting the payload data and the error control data; and at the receive device, checking the payload data using the error control data, in the L2CAP layer. Preferably, the method comprises writing received payload data and error control data into the buffer memory of the receive device, and updating an internal control pointer to show that new payload data has been received; checking the receive payload data using the error control data; and updating a head pointer of the buffer memory to inform the application layer that checked payload data is now present in the buffer memory of the receive device.

According to a second aspect of the present invention there is provided a method of flow control in a Bluetooth wireless communication system, for use at a device having an application layer, an L2CAP layer, and one or more lower layers, the method comprising the steps of: writing payload data from the application layer into a buffer arrangement; reading the payload data from the buffer arrangement into the L2CAP layer for transmission through the lower layers; receiving payload data through the lower layers to the L2CAP layer and writing the received payload data from the L2CAP layer into the buffer arrangement; and retrieving the received payload data from the buffer arrangement into the application layer.

Preferably, the buffer arrangement includes (a) an in-buffer into which the received payload data from the L2CAP layer are written and from which the received payload data are retrieved and (b) an out-buffer into which the payload data from the application layer are written and read into the L2CAP layer.

Preferably the method comprises providing the out-buffer and the in-buffer as memory space shared between the L2CAP layer and application layer for both read and write access. Here, the method may comprise maintaining a set of buffer control pointer for the in-buffer and for the out-buffer to denote current data in each buffer, updating at least one of the buffer control pointers by the application layer, and updating at least one of the buffer control pointers by the L2CAP layer. Preferably the method comprises predicting free space in an in-buffer of a remote device, using the control pointers of the out-buffer. Preferably the method comprises receiving an acknowledgement at the L2CAP layer, confirming safe receipt of transmitted data at a remote device; and updating a buffer control pointer of the buffer arrangement to indicate that current data has been safely transmitted. Optionally, the method comprises re-transmitting payload data from the out-buffer in response to an acknowledgement not being received within a predetermined delay period. Preferably, the acknowledgement contains a size field, and the method comprises the steps of: comparing the size field to confirm that the safely transmitted data corresponds to one or more complete packets of payload data, or determining a flow control error and taking remedial action.

In one preferred embodiment the method comprises establishing a plurality of channels, and allocating a priority level to each channel; and scheduling transmission of payload data from the plurality of channels, according to the priority level of each channel.

In another particularly preferred embodiment the method comprises forming error control data in the L2CAP layer associated with payload data, and transmitting the error control data together with the payload data; and checking received payload data in the L2CAP layer using received error control data, prior to the payload data being retrieved from the in-buffer into the application layer.

According to a third aspect of the present invention there is provided a transmit device having an application layer, an L2CAP layer, and one or more lower layers, and a buffer memory shared between the application layer and the L2CAP layer, the application layer being arranged to write payload data into the buffer memory, and the L2CAP layer being arranged to transmit the payload data from the buffer memory through the lower layers; and a receive device having an application layer, an L2CAP layer, and one or more lower layers, and a buffer memory shared between the L2CAP layer and the application layer, the L2CAP layer being arranged to write payload data received through the lower layers into the buffer memory, and the application layer being arranged to retrieve the received payload data from the buffer memory.

Preferably, each buffer memory comprises a set of buffer control pointers used to denote current data, at least one of the buffer control pointers being updateable by the application layer, and at least one of the buffer control pointers being updateable by the L2CAP layer. Preferably, the buffer control pointers of the buffer memory in the transmit device include a head pointer and a tail pointer denoting a start and end, respectively, of current data in the buffer memory, and an internal pointer used to distinguish between transmitted and untransmitted current data; and the buffer control pointers of the buffer memory and the receive device include a head pointer and a tail pointer denoting current data. Preferably, the L2CAP layer of the receive device is arranged to send an acknowledgement to the L2CAP layer of the transmit device when received payload data has been retrieved by the application layer, such that the tail pointers of the buffer memories are maintained in synchronisation. Preferably, the L2CAP layer of the receive device is arranged to transmit the acknowledgement within a predetermined delay period; and the L2CAP layer of the transmit device is arranged to re-transmit transmitted current data in response to an acknowledgement not being received within the predetermined delay period. Preferably, the acknowledgement includes a size field containing an indication of the size of payload data retrieved from the buffer memory by the application layer; and the L2CAP layer of the transmit device is arranged to check that the size field corresponds to one or more complete packets of transmitted current data in the buffer memory.

In one embodiment, the L2CAP layer of the transmit device comprises a scheduler arranged to schedule a transmission order of payload data in the buffer memory, according to a priority level of a transmission channel allocated to the payload data. In another embodiment, the L2CAP layer of the transmit device is arranged to calculate error control data associated with payload data, and to transmit the payload data together with the error control data; and the L2CAP layer of the receive device is arranged to check the received payload data using the associated error control data.

According to a fourth aspect of the present invention there is provided an application layer containing one or more applications; an L2CAP layer; and a buffer memory shared between the application layer and the L2CAP layer, such that an application in the application layer is arranged to write payload data into the buffer memory and to retrieve payload data from the buffer memory, and the L2CAP layer is arranged to transmit the payload data directly from the buffer memory and to place received payload data directly into the buffer memory.

Preferably, the buffer memory comprises an out-buffer and an in-buffer, the out-buffer being arranged to receive payload data from the application layer for transmission by the L2CAP layer, and the in-buffer being arranged to receive payload data from the L2CAP layer for reading by the application layer. Preferably, the out-buffer comprises a head pointer and a tail pointer to denote current data in the buffer, and an internal pointer to distinguish between transmitted current data and untransmitted current data; and the in-buffer comprises a head pointer and a tail pointer denoting current data in the in-buffer. Preferably, the L2CAP layer is arranged to send an acknowledgement in response to received payload data being read from the in-buffer by the application layer; and the L2CAP layer is arranged to update the tail pointer of the out-buffer upon receipt of the acknowledgement, to maintain the tail pointer in synchronisation with a tail pointer of an in-buffer of a remote device.

In one preferred embodiment, the L2CAP layer is arranged to (a) predict used space in an in-buffer of a remote device using the buffer control pointers of the out-buffer to determine the size of the current transmitted data, and (b) predict available free space in the remote in-buffer by comparing the predicted used space against a declared maximum size of the remote in-buffer.

Preferably, the L2CAP layer is arranged to form the acknowledgement including the size field denoting a size of the received payload data read by the application layer; and the L2CAP layer is arranged to use the size field of an incoming acknowledgement to determine a flow control error, in response to the size field not corresponding to one or more complete packets of payload data.

Preferably, the L2CAP layer is arranged to: (a) send the acknowledgement within a predetermined delay period, and (b) determine a flow control error if an acknowledgement is not received from a remote device within the predetermined delay period.

Preferably the device further comprises a scheduler arranged to schedule transmission of payload data in the buffer memory on one of a plurality of transmission channels, according to a priority level allocated to the transmission channel.

Preferably, a high integrity controller arranged to form error control data associated with payload data, and to check received payload data using associated received error control data.

For a better understanding of the invention, and to show how embodiments of the same may be carried into effect, reference will now be made, by way of example, to the accompanying diagrammatic drawings in which:

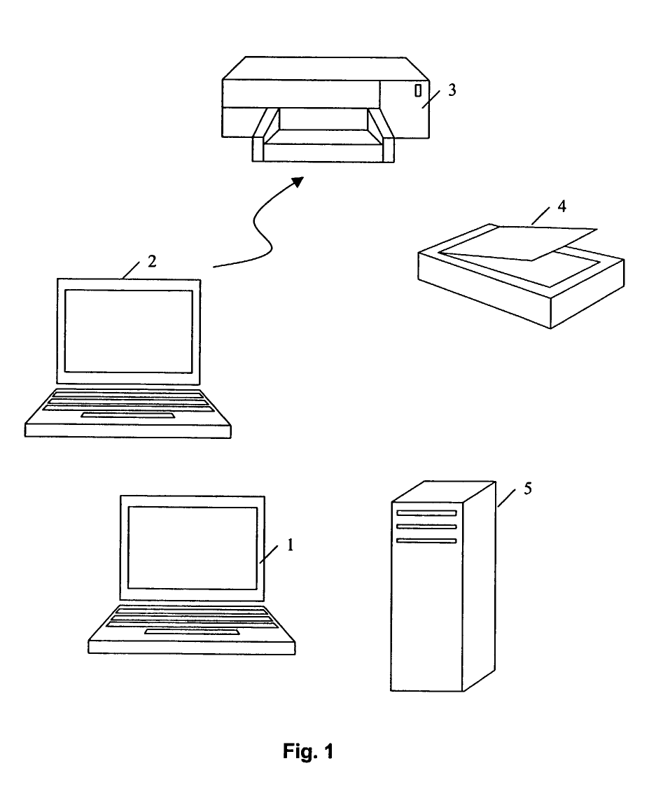

FIG. 1 is a schematic overview of a preferred Bluetooth wireless communication system;

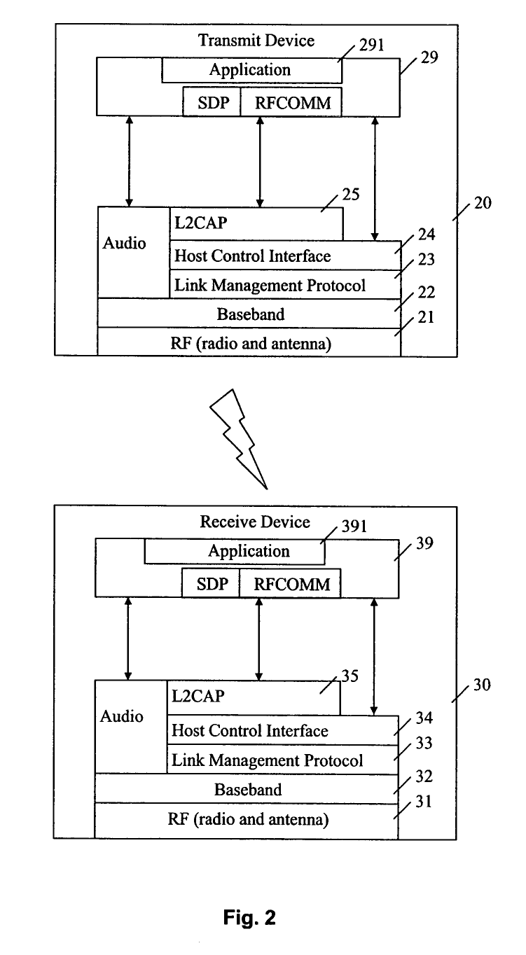

FIG. 2 is a schematic diagram of a protocol stack in a transmit device and in a receive device of a Bluetooth wireless communication system according to a preferred embodiment of the present invention;

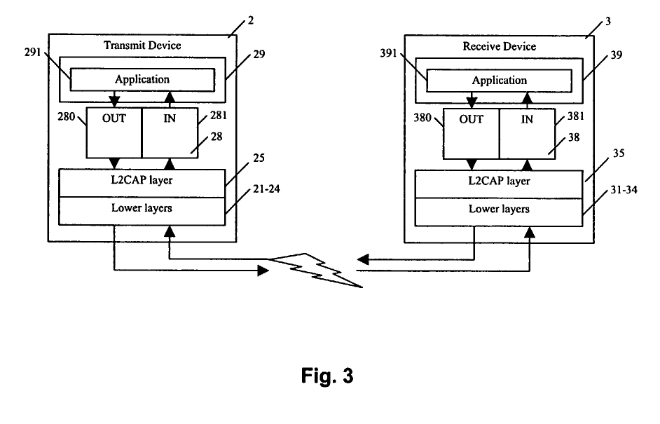

FIG. 3 is a schematic diagram of a buffer memory arrangement employed in preferred embodiments of the present invention;

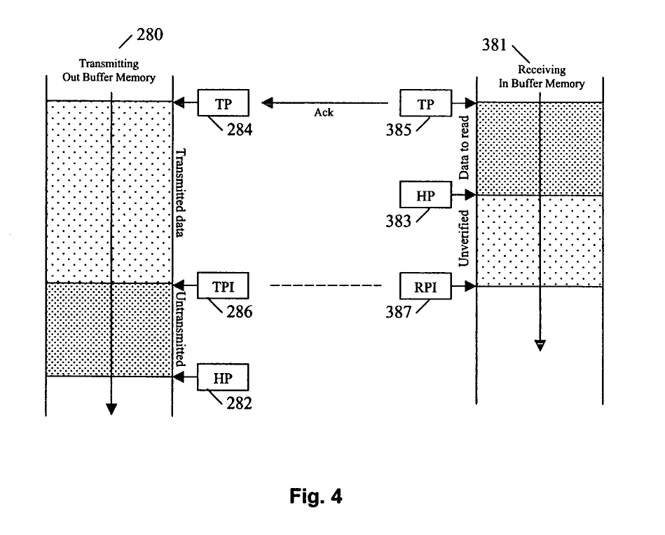

FIG. 4 is a schematic diagram showing the preferred buffer memory arrangement in more detail;

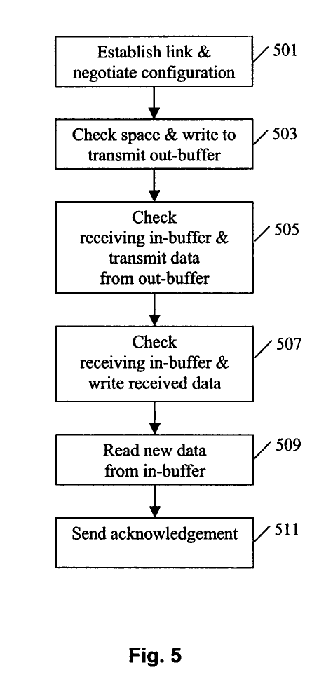

FIG. 5 is a schematic flow diagram of a preferred flow control method;

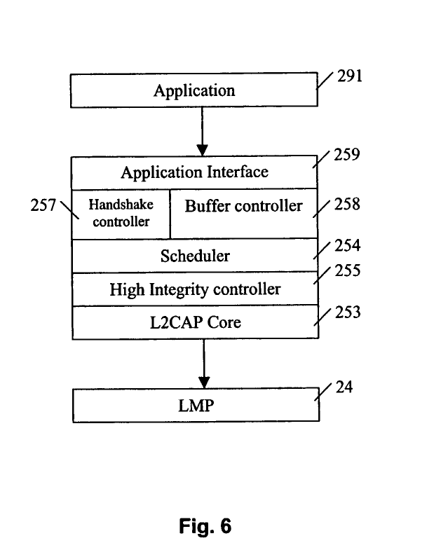

FIG. 6 is a schematic diagram showing a preferred L2CAP layer; and

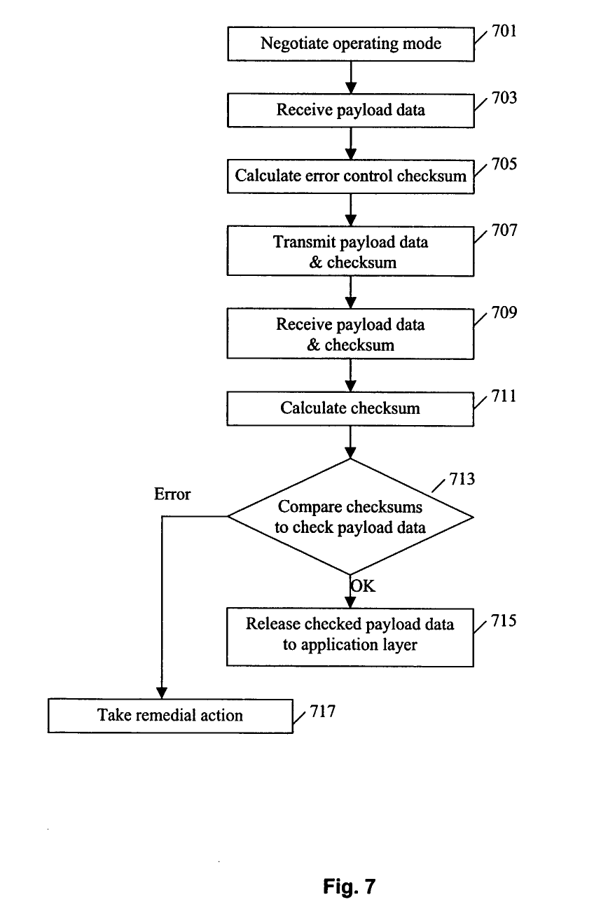

FIG. 7 is a schematic flow diagram of a preferred error control method.

Referring to FIG. 1, a preferred Bluetooth wireless communication system is shown, comprising a plurality of devices 1-5. The devices 1-5 form a local network called a piconet, with one of the devices designated as a master and other devices designated as slaves. In this example, it is desired to transmit data from a transmit device 2 to a receive device 3. Conveniently, the transmit device 2 is the master, and the receive device 3 is one of the slaves. However, other configurations are also possible, such as communications between peer slave devices 2,3 through a separate master device 1. The transmit device 2 is suitably a general purpose computing device such as a desktop personal computer, a laptop or notebook computer, or a personal digital assistant (PDA). Meanwhile, the receive device 3 is suitably an output device such as a printer. However, the exact purpose of each device is not relevant to the present invention, and each device may be of any convenient form.

FIG. 2 shows a protocol stack 20, 30 as employed by the transmit and receive devices 2, 3 respectively.

Lower layers of the transmit device protocol stack 20 include a radio frequency (RF) layer 21, a baseband layer 22, a link management protocol (LMP) layer 23, and a host control interface (HCI) 24.

The RF layer 21 forms a physical connection between the devices, using radio frequency transmissions of about 2.4 GHz. The baseband layer 22 controls the RF layer, including synchronising clocks between devices and establishing connections. Data in the baseband layer is transmitted as baseband packets, which have a length of up to 2745 bits as defined in the Bluetooth specification. A simple form of error correction is provided in the baseband layer 22, by including a 16-bit checksum in each baseband data packet. Various packet types are specified for common applications, which differ in their data capacity and error correction overheads. Also, five different channel types are provided in the baseband layer for control information, link management information, user synchronous data, user asynchronous data, and asynchronous data. In particular, the baseband layer allows two main types of data link to be established, namely SCO (Synchronous Connection-Oriented) links for synchronous data such as voice data, and ACL (Asynchronous Connection-Less) links for data transfer applications which do not require a synchronous link, such as data transfer between a computing device and a printer.

The LMP layer 23 controls piconet management, link configuration and security functions. Usually, the LMP layer 23, the baseband layer 22, and the RF layer 21 are implemented as hardware or firmware.

Above these hardware and firmware layers 21-23 lies a host controller interface 24 that provides logical connections and data transfer to the physical hardware modules of the lower layers. The host controller interface typically includes a HCI driver for physically controlling the hardware elements of the lower layers, according to the construction of a particular host device.

A L2CAP (Logical Link Control and Adaptation Protocol) layer 25 provides a logical interface between the lower mainly hardware implemented layers 21-24, and higher typically software implemented layers including an application layer 29. In particular, the L2CAP layer 25 performs segmentation and reassembly of payload data. During transmission, the L2CAP layer 25 accepts packets of payload data of a size up to 64 kb, and segments the payload data into baseband packets of a size at most 2745 bits. The reverse procedure of reassembling baseband packets into the proper order to recreate original payload data is carried out when receiving data. The L2CAP layer 25 provides other functions such as quality of service (QoS) on certain parameters such as peak bandwidth, latency and delay variation, and provides channel multiplexing to allow multiple applications to use a single physical link between two devices.

The application layer 29 contains one or more higher-level applications 291, which interact with the L2CAP layer 25 to transmit and receive data over the Bluetooth wireless communication network. These applications 291 may take any suitable form, and are tailored to the operating environment of a particular host device 2, 3, such as a PC or printer or other device.

An equivalent protocol stack 30 is provided in the receive device 3, including an application layer 39 with one or more applications 391, a L2CAP layer 35, and lower layers 31-34.

It is desired to provide robust and stable control of data flow to one or more applications 291, 391 in the application layer 29, 39, ideally without incurring significant overhead or adding latency.

Briefly, flow control is obtained by adapting the L2CAP layer 25, 35 to control a dual-ported buffer memory that is shared between the L2CAP layer 25, 35 and the application layer 29, 39. As will be explained in more detail below, the modified L2CAP layer 25, 35 manages the buffer memory to control data flow to or from an application 291, 391 in the application layer 29, 39.

FIG. 3 shows a buffer memory arrangement employed in preferred embodiments of the present invention. The transmit device 2 and the receive device 3 each include a buffer memory 28, 38. Each buffer memory 28, 38 includes an out-buffer 280, 380, and an in-buffer 281, 381, allowing bi-directional flow control between the devices.

In the transmit device 2, outgoing data is transmitted through the out-buffer 280, to be received by the in-buffer 381 of the receive device 3. Likewise, a return channel is provided through out-buffer 380 into in-buffer 281.

Each buffer memory 28, 38 is suitably a dual ported memory, and the buffer memory 28, 38 is shared between the application layer 29, 39 and the L2CAP layer 25, 35. That is, the buffer memory 28, 38 is made available to read and write by both of the L2CAP layer 25, 38 and the application layer 29, 39.

Most conveniently, each buffer memory 28, 38 is provided by resources of the host device allocated to the application 291, 391 in the application layer 29, 39. Alternately, the buffer memories are created in resources allocated to the L2CAP layer 25, 35. In a multi-channel environment, a buffer memory 28, 38 is provided for each channel, or a buffer memory 28,38 is shared between multiple channels.

Each buffer memory is suitably implemented as a ring or cyclic buffer, such that the content of the buffer wraps around from the end of the buffer space to the beginning. Other forms of buffer such as FIFO (first in first out) are also applicable.

FIG. 4 is a schematic diagram showing in more detail the out-buffer 280 of the transmit device 2, and the in-buffer 381 of the receive device 3. Each buffer is suitably defined by parameters including a start pointer, and a buffer size in bytes. These parameters are exchanged between the devices, particularly so that the transmit device 2 is able to track available space within the in-buffer 381 of the receive device 3.

The out-buffer 280 is controlled by a head pointer HP 282, and a tail pointer TP 284. HP and TP are accessible both to the application 291 and to the L2CAP layer 25. Further, the out-buffer is controlled by an internal tail pointer TPI 286 which is accessible only to the L2CAP layer 25.

Similarly, the in-buffer 381 is controlled by a head pointer HP 283 and a tail pointer TP 385 accessible to both the application 391 and to the L2CAP layer 35, and optionally by an internal received pointer RPI 387 which is accessible only to the L2CAP layer 35.

These control pointers 282-286, 383-387 are suitably stored at the beginning of each buffer. The remainder of the buffer is then available to store payload data. In the out-buffer 280, the head pointer HP 282 points to the location in the buffer where new payload data is to be written by the application 291. The tail pointer TP 284 points to the location in the buffer where data has been transmitted and a positive acknowledgement received. The distance between HP 282 and TP 284 denotes current data in the transmit out-buffer 280. The internal pointer TPI 286 points to the location in the buffer where data has been transmitted, but for which an acknowledgement has not yet been received. Hence, the L2CAP layer 25 is able to distinguish between untransmitted data waiting in the transmit out-buffer 280, and data which has been transmitted but for which a successful acknowledgement has not yet been received. This allows re-transmission of data in the event of a transmission error. The control pointers 282-286 allow double buffering of the transmit out-buffer, whilst using a single memory space.

The control pointers HP 383 and TP 385 in the receiving in-buffer 381 likewise track current data. The control pointer RPI 387 will be described in more detail later, and again allows double-buffering of the in-buffer 381 using a single memory space.

FIG. 5 is a flowchart of a preferred flow control method, using the buffer memories 28, 38.

Firstly, in step 501, a link is established between the transmit device 2 and the receive device 3. Step 501 includes negotiating either a legacy operating mode, or an enhanced operating mode with L2CAP flow control. In particular, it is desired to confirm that both the transmit and receive devices 2,3 are capable of performing the L2CAP flow control mechanism. Negotiation is initialised by sending a configuration request such as from the transmit device 2 to the receive device 3. The configuration request conveniently makes use of a standard configuration request procedure defined in the Bluetooth specification version 1.1, i.e. sending an L2CA_ConfigReq message. The configuration request message contains parameters that are meaningless to a device which does not include an L2CAP layer that supports flow control. Hence, if the receive device does not include an adapted L2CAP layer, then a negative confirmation is returned, i.e. L2CA ConfigRspNeg, and the devices operate in the legacy mode, according to the existing Bluetooth specification version 1.1. However, where both devices do include an adapted L2CAP layer, then a positive confirmation is issued, i.e. L2CA_ConfigRsp, and the enhanced L2CAP flow control mode is established.

The negotiation of step 501 includes passing configuration parameters between the devices 2, 3. These parameters suitably include the size of the in and out-buffers of each device, defined such as by a start pointer and a size in bytes. Also, it is useful to pass a parameter defining a maximum transmission unit (MTU) size.

Step 503 comprises checking that available space exists in the out-buffer 280 of the transmit device, and then writing data to be transmitted into that available space. Here, the application 291 in the application layer 29 uses the HP and TP control pointers to determine the current data in the out buffer, and then subtracts the size of the current data from the total size. If the data to be written cannot fit within the available space, then the application 291 waits until sufficient space is available. Otherwise, the application writes the payload data into the transmit out-buffer 280, and updates the head pointer HP 282 to point to the next location in the buffer where data is to be written.

In step 505, data is transmitted from the out-buffer 280. Here, the L2CAP layer 25 determines that data awaits transmission, such as by comparing the TP and HP pointers. The L2CAP layer 25 then schedules transmission of the written data, such as by starting at the tail pointer TP 284. As data is transmitted, the L2CAP layer 25 updates the internal control pointer TPI 286, but does not yet update the TP pointer 284. Hence, transmitted data is retained in the out-buffer 280 to allow re-transmission should an error occur. Also, retention of the transmitted data alleviates link degradation should the receive device 3 be unable to respond immediately.

Also in step 505, the transmitting L2CAP layer 25 monitors available space in the in-buffer 381 of the receive device 3. The maximum size of the in-buffer 381 has been declared during the link configuration of step 501. Conveniently, available space in the receiving in-buffer 381 is predicted using the control points TP and TPI of the out-buffer 280, i.e. denoting the size of the transmitted data for which an acknowledgement has yet to be received. This transmitted but unacknowledged data is assumed to be lying in the in-buffer 381, and is subtracted from the declared maximum size of the receiving in-buffer. Thus, a prediction of the free space in the receiving in buffer is obtained indirectly, without having to interrogate the receive device 3.

In order for a transmission to take place, the available free space in any buffer should be equal to or greater than the declared maximum transmission unit MTU size. If the transmitting L2CAP layer 25 determines that the in-buffer 381 of the receive device 3 is full, then transmission waits until sufficient space is available.

At step 507, the L2CAP layer 35 of the receive device 3 checks for available space in the in-buffer 381, using the control pointers 383-387. Where sufficient space is available, the received payload data is written into the in-buffer 381, and the L2CAP layer 35 updates the head control pointer HP 383.

If sufficient space is not available in the in-buffer 381 then, to avoid a buffer over-run, an error condition is reported and remedial action taken such as disconnection of the link. Here, it is assumed that a serious error has occurred, because the status of the in-buffer 381 has not been predicted correctly by the transmit device 2.

In step 509, the receiving application 391 checks for the presence of new incoming data in the in-buffer 381, i.e. when the HP and TP control pointers are not equal. The application 391 then reads data from the in-buffer 381, and updates the tail pointer TP 385 to show that this data has been read.

In the preferred method, received data remains in the in-buffer 381 until the receiving application 391 is ready to read that incoming data. Hence, a faster transmit device 2 is able to transmit data to a slower receive device 3, without causing delays at the transmit device 2.

In step 511, the receiving L2CAP layer 35 sends an acknowledgement to the transmitting L2CAP layer 25. It is preferred that acknowledgement of read data is relayed to the transmit device using a delayed ping-pong mechanism. A conventional ping-pong mechanism assumes that every transmitted packet is acknowledged before the next packet is transmitted. The preferred delayed ping-pong mechanism allows the remote L2CAP layer 35 to delay acknowledgement without blocking the channel. Suitably, a maximum delay time is defined, in which the receiving L2CAP layer 35 must acknowledge receipt of a transmitted data packet.

Acknowledgement is provided in the form of an acknowledgement control packet sent from the receiving L2CAP layer 35 to the transmitting L2CAP layer 25. Suitably, an acknowledgement control packet is sent after one or more complete payload data packets have been read from the in-buffer 381 by the receiving application 391. The transmitting L2CAP layer 25 then updates its own tail pointer TP, to show that the transmitted data has been safely received and to free that space in the transmit out-buffer 280.

Keeping track of the status of the remote in-buffer 381 can lead to deadlocks, buffer under-run and buffer over-run, should undetected errors occur in the acknowledgement process. Therefore, the acknowledgement control packet includes a size field indicating the number of bytes that have been read by the receiving application since the last acknowledgement. The transmitting L2CAP layer 25 checks that the returned size field falls at a packet boundary.

In the event of a flow control error, indicated such as by the lack of an acknowledgement within a specified delay period, or by an acknowledgement with a size field that does not fall at a packet boundary, then the transmitting device 2 takes suitable remedial action, such as retransmitting payload data or disconnecting the link. Retransmission is accomplished simply and easily by resetting the control pointers 282-286, since the data to be retransmitted still exists in the out-buffer 280.

The buffer memories 28, 38 are synchronised, in that the TP tail pointer of the out and in buffers 280,381 move in step with one another. However, the buffers 28, 38 need not be of equal size. For example, a slow receiving device provides a larger buffer when communicating with a faster transmitting device, in order that transmission is not delayed for the faster device. Further, the in and out buffers 380, 381 within a buffer memory 38 need, not be of equal size, and may be adjusted according to current load.

FIG. 6 is a schematic diagram showing the construction of the L2CAP layer 25, 35 in more detail.

The preferred L2CAP layer 25 includes an L2CAP core 253, a scheduler 254, a high integrity controller 255, a handshake controller 256, a buffer controller 258, and an application interface 259.

The L2CAP layer is suitably implemented as hardware, firmware, or preferably as software. The modular construction shown in FIG. 6 allows existing host devices to implement the functions described herein, simply by loading modified software for the L2CAP layer. Further, this modular construction allows additional features of the L2CAP layer to be made available as required during implementation. Some of the optional functions need not be implemented if not required in a particular host device. Hence the preferred modular construction of the L2CAP layer is particularly suited to devices having limited resources for computing power, memory or power supply, such as a handheld computing device, or a cellular telephone.

The L2CAP core 253 provides an interface from the L2CAP layer 25 to lower layers 21-24 of the protocol stack, according to the existing Bluetooth specification version 1.1. Hence, the preferred embodiment is transparent to the lower layers 21-24, thereby minimising impact to existing host devices and implementations.

The handshake controller 256 controls negotiation of operating modes between the devices 2,3, including the transfer of configuration parameters. Also, the handshake controller manages the flow of control data, including acknowledgement control packets.

The buffer controller 258 provides the flow control functions discussed herein.

The application interface 259 optionally provides a translator than enables legacy applications to interface with the adapted L2CAP layer 25. A legacy application expects to interact with an L2CAP layer that operates according to the existing Bluetooth specification version 1.1. Hence, the translator in the application interface 259 re-formats requests from the legacy application to fall within the expectations of the adapted L2CAP layer 25, and also interprets responses from the adapted L2CAP layer to be understood by legacy applications. In particular, the translator determines the in-buffer start pointer from a legacy configuration L2CA_ReadData, and an out-buffer start pointer from a legacy configuration L2CA_WriteData. In use, the translator sets buffer sizes equal to the maximum transmission unit MTU size extracted from the legacy configuration process. The translator then determines the response for L2CA_WriteData and L2CA_ReadData commands from the buffer control pointers (HP, TP, etc.) and presents these to the legacy application accordingly. In the preferred implementation, the translator sets the in-buffer size to be 1 byte larger than the MTU, and keeps resetting the buffer control pointers held by the buffer controller 258 after each Read or Write -access in order to maintain flow. Minimal buffering is provided in this example legacy mode.

Optionally, the scheduler 254 provides channel prioritisation in a multi-channel environment, whilst the high integrity controller 255 provides improved error control. The scheduler 254 and the high integrity controller 255 will now be discussed in more detail.

The existing Bluetooth specification version 1.1 does not allow channels to be prioritised. Hence, current L2CAP implementations operate on a first come first served basis. However, it is desired that some channels should have a higher priority than other channels. For example, a payload data channel used to send control information to an application running on a device should have a higher priority than a channel used for other data.

In the preferred embodiment, a channel priority is negotiated when a link is established. From then on, the scheduler uses the priority level for each channel to schedule transmission of data from the out-buffer 280. Suitably, the priority level includes at least one supervisory level, and at least one normal level. Supervisory channels are served first, and are suitably used for communication between L2CAP layers for sending L2CAP control data such as acknowledgement packets. Normal channels are then serviced in order of priority for transmission of payload data.

FIG. 7 is a schematic flow diagram showing an overview of the preferred error control method, performed using the high integrity controller 255.

Although data transmission within the Bluetooth wireless communication system is generally reliable, unfortunately it has been found that transmission errors occasionally do occur such as due to RF interference. More importantly, such data errors may go undetected. A data error may, for example, cause the receive device 3 to malfunction, such as a printer producing unnecessary page feeds or printing garbage data. Following such an error, it is usually necessary to disconnect a transmission link established between the devices, causing a delay and inconvenience for a user.

In the preferred error control method of FIG. 7, step 701 comprises negotiating either a normal mode or a high integrity mode of operation for a channel. Conveniently, an integrity field is added to the negotiated configuration parameters. A request for the high integrity mode is suitably made by the transmit device 2. However, it is preferred that a receive device 3 which is particularly vulnerable to erroneous data, such as a printer, initiates negotiation of the high integrity mode, if the transmit device 2 does not do so.

In the transmit device 2, payload data is received from the application layer 29 into the L2CAP layer 25, at step 703. That is, new payload data is written into the out-buffer 280. The payload data is suitably divided into one or more L2CAP payload data packets, each of a size up to 64 Kb.

Step 705 comprises calculating error control data from the payload data. Here, the high integrity controller 255 in the L2CAP layer 25 of the transmit device 2 calculates an error checking checksum for the payload in each data packet. The checksum is suitably based on CRC-32 (Ethernet). In the preferred embodiment, a 32-bit polynomial has been chosen for robust error detection. In other embodiments of the invention, other forms of error detection are employed. For example, the checksum is replaced by error control data that allows both error checking and correction (ECC).

The error control data is suitably appended to the payload data of each payload data packet. Alternatively, the checksum data is sent in a separate data packet, ideally immediately following the corresponding payload data packet.

In step 707, the payload data and associated error control data are transmitted using the lower layers 21-24 of the transmit device 2, to be received at the receive device 3.

At the receive device 3, the payload data and error control data are received in the lower layers 31-34 and passed to the L2CAP layer 35, at step 709. The received payload data and error control data are written into the in-buffer 381 by the receiving L2CAP layer 35. Referring again briefly to FIG. 5, the internal buffer control pointer RPI 387 is updated to show that new data has been received. At this stage, the head pointer HP is not yet updated, such that the newly received data is not yet made available to the receiving application 391.

In steps 711 and 713, the received payload data is checked, using the received error control data, in the receiving high integrity controller 255. That is, the high integrity controller 255 calculates a checksum for the received payload data at step 711, and compares the calculated checksum against the received checksum of the error control data at step 713. Ideally, the high integrity controller 255 calculates the checksum as data is received, to reduce latency.

At step 715, assuming that no errors are detected, the head pointer HP 383 is updated toward the RPI pointer 387, to indicate that valid data is available in the in-buffer 381 ready to be read by the receiving application 391.

On the other hand, if the received data fails the integrity check and an error is detected, or if no error control data is received, then remedial action is taken at step 717. Suitably, a negative acknowledgement control packet is sent to the transmit device 2, and remedial action taken. For example, the link is disconnected, or the buffers are flushed. Preferably, the negative acknowledgement provides a current value of the head pointer HP 383 of the receive in-buffer 381, which is used by the transmitting L2CAP layer 25 to reset the internal control pointer TPI 286 to point to the offending packet, allowing retransmission of all data from that point.

The error control mechanism shown in FIG. 7 is separate from, and additional to, an error control mechanism provided in the baseband layer 22 according to the existing Bluetooth specification version 1.1. Whilst the baseband error control is generally reliable, the preferred error control mechanism in the L2CAP layer offers even more robust data transmission on a per-channel basis.

It is preferred that the devices 2, 3 each resume the normal mode whenever a link is disconnected. Most devices do not require the high integrity mode, but the function is particularly useful in some environments, such as data transmission between a computer and a printer. The high integrity mode is applicable unidirectionally such as from a transmit device to a receive device, and optionally is applicable bi-directionally, to provide improved error control for data in both directions between the two devices.

The preferred wireless communication system and data control methods described herein have a number of advantages. In particular, robust and reliable flow control is achieved by providing a central buffering mechanism administered by the L2CAP layer. Overall, minimal computational overhead is incurred. Buffer management previously performed in the application layer of the host device is now redundant. Further, the adapted L2CAP layer of the preferred embodiment of the present invention requires each application to admit flow control buffering. Compatibility is maintained with the existing hardware or firmware in lower layers of the protocol stack, allowing the adapted L2CAP layer to be implemented on existing host devices with minimal adaptations. Optionally, channel priority is achieved. Further, a high integrity mode of operation with improved error control is provided. The flow control method and Bluetooth wireless communication system described herein minimises vulnerability to channel blockage and improves stability, particularly for multi-channel environments. Other advantages and features of the invention will be apparent from the foregoing description.

1. A flow control method for use in a Bluetooth wireless communication system that includes a transmit device and a receive device, the transmit and the receive devices each comprising an application layer, an L2CAP layer, and one or more lower layers, each of the devices including a buffer memory shared between the application layer and the L2CAP layer, the method comprising the steps of:
in the transmit device, writing payload data from the application layer into the buffer memory, and transmitting the payload data from the buffer memory through the L2CAP layer; and
in the receive device, placing payload data received through the L2CAP layer into the buffer memory, and reading payload data from the buffer memory into the application layer.

2. The method of claim 1, comprising the steps of:
controlling the shared buffer memory using a set of buffer control pointers;
updating at least one of the set of buffer control pointers, from the application layer; and
updating at least one of the buffer control pointers, from the L2CAP layer.

3. The method of claim 2, wherein the set of buffer control pointers includes a head pointer and a tail pointer, and the method comprises:
updating the head pointer using the application layer, to show that new payload data has been written into the buffer memory of the transmit device; and
updating a tail pointer of the buffer memory of the transmit device using the L2CAP layer, to show that payload data has been successfully transmitted.

4. The method of claim 3, wherein the buffer memory of the transmittal device comprises an outgoing buffer memory, and further comprising the step of:
calculating free space in the buffer memory of the transmit device using the head and tail pointers, prior to writing payload data from the application layer into the outgoing buffer memory.

5. The method of claim 1, wherein the buffer memory of the receive device comprises an incoming buffer memory, and further comprising the step of:
in the transmit device, predicting available space in the incoming buffer memory of the receive device, prior to transmitting payload data to the receive device.

6. The method of claim 5, wherein the predicting step comprises:
in the transmit device, maintaining a set of buffer control pointers for the outgoing buffer memory, including a head pointer, a tail pointer, and an internal pointer, such that the head and tail pointers denote a start and end, respectively, of current payload data in the outgoing buffer memory, and the internal pointer distinguishes untransmitted current data from transmitted current data; and
calculating the size of the transmitted current data using the set of control pointers of the outgoing buffer memory, to predict available space in the incoming buffer memory of the receive device.

7. The method of claim 1, comprising the step of:
in the receive device, confirming that available space exists in the buffer memory of the receive device, prior to writing received payload data from the L2CAP layer into the buffer memory.

8. The method of claim 1, comprising the steps of:
sending an acknowledgement from the L2CAP layer of the receive device to the L2CAP layer of the transmit device, when payload data is read from the buffer memory of the receive device by the application layer; and
in the transmit device, updating a tail pointer representing an end of current data in the buffer memory of the transmit device, in response to the acknowledgement, to show that the read payload data has been successfully transmitted.

9. The method of claim 8, wherein the acknowledgement includes a size field indicating a number of bytes that have been read, and the method comprises, in the transmit device, checking that the read number of bytes falls at a packet boundary.

10. The method of claim 1, comprising the steps of:
in the transmit device, determining a flow control error; and
re-transmitting payload data from the outgoing buffer memory.

11. The method of claim 1, comprising the steps of:
establishing a transmission link between the transmit device and the receive device; and
exchanging configuration parameters including a maximum size of the buffer memory of the transmit device and the buffer memory of the receive device.

12. The method of claim 1, comprising the steps of:
negotiating a transmission channel between the transmit device and the receive device, including negotiating either a legacy mode without flow control in the L2CAP layer or an enhanced mode that includes flow control in the L2CAP layer.

13. The method of claim 1, comprising the steps of:
establishing a plurality of transmission channels, each transmission channel having a priority level amongst a plurality of predetermined priority levels; and
scheduling transmission of payload data in the outgoing buffer, according to the priority level of the transmission channel of the payload data.

14. The method of claim 1, comprising the steps of:
negotiating a high integrity mode between the transmit device and the receive device;
at the transmit device, forming error control data in the L2CAP layer for each packet of payload data, and transmitting the payload data and the error control data; and
at the receive device, checking the payload data using the error control data, in the L2CAP layer.

15. The method of claim 14, comprising the steps of:
writing received payload data and error control data into the buffer memory of the receive device, and updating an internal control pointer to show that new payload data has been received;
checking the receive payload data using the error control data; and
updating a head pointer of the buffer memory of the receive device to inform the application layer that checked payload data is now present in the buffer memory of the receive device.

16. A method of flow control in a Bluetooth wireless communication system, for use at a device having an application layer, an L2CAP layer, and one or more lower layers, the method comprising the steps of:
writing payload data from the application layer into a buffer arrangement;
reading the payload data from the buffer arrangement into the L2CAP layer for transmission through the lower layers;
receiving payload data through the lower layers to the L2CAP layer and writing the received payload data from the L2CAP layer into the buffer arrangement; and
retrieving the received payload data from the buffer arrangement into the application layer.

17. The method of claim 16 wherein the buffer arrangement includes (a) an in-buffer into which the received payload data from the L2CAP layer are written and from which the received payload data are retrieved and (b) an out-buffer into which the payload data from the application layer are written and read into the L2CAP layer.

18. The method of claim 17, comprising providing the out-buffer and the in-buffer as memory space shared between the L2CAP layer and application layer for both read and write access.

19. The method of claim 18, comprising maintaining a set of buffer control pointers for the in-buffer and for the out-buffer to denote current data in each buffer, updating at least one of the buffer control pointers by the application layer, and updating at least one of the buffer control pointers being updateable by the L2CAP layer.

20. The method of claim 19, comprising predicting free space in an in-buffer of a remote device, using the control pointers of the out-buffer.

21. The method of claim 20, comprising the steps of:
receiving an acknowledgement at the L2CAP layer, confirming safe receipt of transmitted data at a remote device; and
updating a buffer control pointer of the buffer arrangement to indicate that current data has been safely transmitted.

22. The method of claim 21, comprising re-transmitting payload data from the out-buffer in response to an acknowledgement not being received within a predetermined delay period.

23. The method of claim 21, wherein the acknowledgement contains a size field, and the method comprises the steps of:
comparing the size field to confirm that the safely transmitted data corresponds to one or more complete packets of payload data, or determining a flow control error and taking remedial action.

24. The method of claim 16, comprising the steps of:
establishing a plurality of channels, and allocating a priority level to each channel; and
scheduling transmission of payload data from the plurality of channels, according to the priority level of each channel.

25. The method of claim 16, comprising the steps of:
forming error control data in the L2CAP layer associated with payload data, and transmitting the error control data together with the payload data; and
checking received payload data in the L2CAP layer using received error control data, prior to the payload data being retrieved from the in-buffer into the application layer.

26. A Bluetooth wireless communication system, comprising:
a transmit device having an application layer, an L2CAP layer, and one or more lower layers, and a buffer memory shared between the application layer and the L2CAP layer, the application layer being arranged to write payload data into the buffer memory, and the L2CAP layer being arranged to transmit the payload data from the buffer memory through the lower layers; and
a receive device having an application layer, an L2CAP layer, and one or more lower layers, and a buffer memory shared between the L2CAP layer and the application layer, the L2CAP layer being arranged to write payload data received through the lower layers into the buffer memory, and the application layer being arranged to retrieve the received payload data from the buffer memory.

27. The system of claim 26, wherein each buffer memory comprises a set of buffer control pointers used to denote current data, at least one of the buffer control pointers being updateable by the application layer, and at least one of the buffer control pointers being updateable by the L2CAP layer.

28. The system of claim 27, wherein:
the buffer control pointers of the buffer memory in the transmit device include a head pointer and a tail pointer denoting a start and end, respectively, of current data in the buffer memory, and an internal pointer used to distinguish between transmitted and untransmitted current data; and
the buffer control pointers of the buffer memory and the receive device include a head pointer and a tail pointer denoting current data.

29. The system of claim 28, wherein the L2CAP layer of the receive device is arranged to send an acknowledgement to the L2CAP layer of the transmit device when received payload data has been retrieved by the application layer, such that the tail pointers of the buffer memories are maintained in synchronisation.

30. The system of claim 29, wherein:
the L2CAP layer of the receive device is arranged to transmit the acknowledgement within a predetermined delay period; and
the L2CAP layer of the transmit device is arranged to re-transmit transmitted current data in response to an acknowledgement not being received within the predetermined delay period.

31. The system of claim 29, wherein:
the acknowledgement includes a size field containing an indication of the size of payload data retrieved from the buffer memory by the application layer; and
the L2CAP layer of the transmit device is arranged to check that the size field corresponds to one or more complete packets of transmitted current data in the buffer memory.

32. The system of claim 26, wherein the L2CAP layer of the transmit device comprises a scheduler arranged to schedule a transmission order of payload data in the buffer memory, according to a priority level of a transmission channel allocated to the payload data.

33. The system of claim 26, wherein:
the L2CAP layer of the transmit device is arranged to calculate error control data associated with payload data, and to transmit the payload data together with the error control data; and
the L2CAP layer of the receive device is arranged to check the received payload data using the associated error control data.

34. A device adapted for use in a Bluetooth wireless communication system, the device comprising:
an application layer containing one or more applications;
an L2CAP layer; and
a buffer memory shared between the application layer and the L2CAP layer, such that an application in the application layer is arranged to write payload data into the buffer memory and to retrieve payload data from the buffer memory, and the L2CAP layer is arranged to transmit the payload data directly from the buffer memory and to place received payload data directly into the buffer memory.

35. The device of claim 34, wherein the buffer memory comprises an out-buffer and an in-buffer, the out-buffer being arranged to receive payload data from the application layer for transmission by the L2CAP layer, and the in-buffer being arranged to receive payload data from the L2CAP layer for reading by the application layer.

36. The device of claim 35, wherein:
the out-buffer comprises a head pointer and a tail pointer to denote current data in the buffer, and an internal pointer to distinguish between transmitted current data and untransmitted current data; and
the in-buffer comprises a head pointer and a tail pointer denoting current data in the in-buffer.

37. The device of claim 36, wherein:
the L2CAP layer is arranged to send an acknowledgement in response to received payload data being read from the in-buffer by the application layer; and
the L2CAP layer is arranged to update the tail pointer of the out-buffer upon receipt of the acknowledgement, to maintain the tail pointer in synchronisation with a tail pointer of an in-buffer of a remote device.

38. The device of claim 36, wherein the L2CAP layer is arranged to: (a) predict used space in an in-buffer of a remote device using the buffer control pointers of the out-buffer to determine the size of the current transmitted data, and (b) predict available free space in the remote in-buffer by comparing the predicted used space against a declared maximum size of the remote in-buffer.

39. The device of claim 37, wherein:
the L2CAP layer is arranged to form the acknowledgement including the size field denoting the size of the received payload data read by the application layer; and
the L2CAP layer is arranged to use the size field of an incoming acknowledgement to determine a flow control error, in response the size field not corresponding to one or more complete packets of payload data.

40. The device of claim 37, wherein the L2CAP layer is arranged to: (a) send the acknowledgement within a predetermined delay period, and (b) determine a flow control error if an acknowledgement is not received from a remote device within the predetermined delay period.

41. The device of claim 34, further comprising:
a scheduler arranged to schedule transmission of payload data in the buffer memory on one of a plurality of transmission channels, according to a priority level allocated to the transmission channel.

42. The device of claim 34, wherein the L2CAP layer comprises:
a high integrity controller arranged to form error control data associated with payload data, and to check received payload data using associated received error control data.
